(19) United States
(12) Patent Application Publication
(10) Pub. No.: US 2003/0075621 A1
(43) Pub. Date: Apr. 24, 2003

(54) Fuel injection sleeve armature

(75) Inventor: Gregory R. Morton, Yorktown, VA (US)

Correspondence Address: MORGAN LEWIS & BOCKIUS LLP, 1111 PENNSYLVANIA AVENUE NW, WASHINGTON, DC, 20004, US

(73) Assignee: Siemens Automotive Corporation

(21) Appl. No.: 09/970,677

(22) Filed: Oct. 5, 2001

(51) Int. Cl. B05B 1/30; F02M 51/00

(52) U.S. Cl. 239/585.1

(57) ABSTRACT

A fuel injector having a housing including an inlet, an outlet, and a passageway for fuel flow from the inlet to the outlet. A coil assembly is disposed proximate the inlet of the fuel injector. A seat is disposed proximate the outlet of the fuel injector. A closure member is disposed in the housing and operable by the coil assembly to permit and prohibit fuel flow through the seat. The closure member includes a sleeve and an armature. The sleeve extends along a longitudinal axis and has first and second ends, the sleeve including an outer surface a first distance from the longitudinal axis. The armature is coupled to the first end of the sleeve, the armature having an outer perimeter a second distance from the longitudinal axis, the second distance not greater than the first distance.

### FIELD OF INVENTION

The invention relates to a closure member for a fuel injector, and more particularly to a closure member that defines a working gap between the exterior surface of a sleeve and the interior surface of an actuator.

### BACKGROUND OF THE INVENTION

It is known to use a variety of sealing mechanisms to permit and inhibit fuel flow through fuel injectors. These mechanisms include needle and armature, ball and armature, and ball and disk combinations. It is believed that a radial working gap between the sealing mechanism and the coil of the fuel injector must be set to optimize the magnetic properties of the injector. It is known to use a variety of processes on the outer diameter of the armature to determine the working gap, including chroming, separate machining operations, and eyelet crimping. These processes suffer from disadvantages including additional manufacturing steps, added components, and increased costs.

### SUMMARY OF THE INVENTION

The present invention provides a fuel injector having a housing including an inlet, an outlet, and a passageway for fuel flow from the inlet to the outlet. A coil assembly is disposed proximate the inlet of the fuel injector. A seat is disposed proximate the outlet of the fuel injector. A closure member is disposed in the housing and operable by the coil assembly to permit and prohibit fuel flow through the seat. The closure member includes a sleeve and an armature. The sleeve extends along a longitudinal axis and has first and second ends, the sleeve including an outer surface a first distance from the longitudinal axis. The armature is coupled to the first end of the sleeve, the armature having an outer perimeter a second distance from the longitudinal axis, the second distance not greater than the first distance. A surface of the sleeve defines a working surface for a working gap between the sleeve and the coil. Preferably, the working gap is less than about 100 microns.

The present invention further provide a method of defining a working gap of less than 100 microns in a fuel injector including an electromagnetic actuator having an inner surface, and a closure member having a longitudinal axis and operable by the electromagnetic actuator. The closure member with a sleeve and the armature coupled to the sleeve are arranged such that the sleeve provides a working surface for the working gap. The working gap of less than 100 microns is established between the inner surface of the electromagnetic actuator and the working surface of the sleeve.

The present invention further provides a closure assembly for a fuel injector including a housing. An electromagnetic actuator is disposed in the housing and has an inner surface. A closure member is disposed in the housing and is operable by the actuator to permit and prohibit fuel flow through the fuel injector. The closure member includes a sleeve and an armature. The sleeve extends along a longitudinal axis, the sleeve having an end and an outer surface. The armature is coupled to the end of the sleeve and is disposed entirely within a volume of the outer surface of the sleeve extending along the longitudinal axis.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 shows a cross-sectional view of a fuel injector assembly including the closure member.

FIG. 2 shows an elevation view of the sleeve.

FIG. 3 shows a top view of the sleeve of FIG. 2.

FIG. 4 shows a cross sectional view of the armature.

FIG. 5 shows an elevation view of the armature of FIG. 4.

FIG. 6 shows an elevation view of an embodiment of the closure member including a needle.

FIG. 7 shows an elevation view of another embodiment of the closure member including a ball.

FIG. 8 shows magnetic flux flow paths through the magnetic circuit.

### DETAILED DESCRIPTION OF THE PREFERRED EMBODIMENT(S)

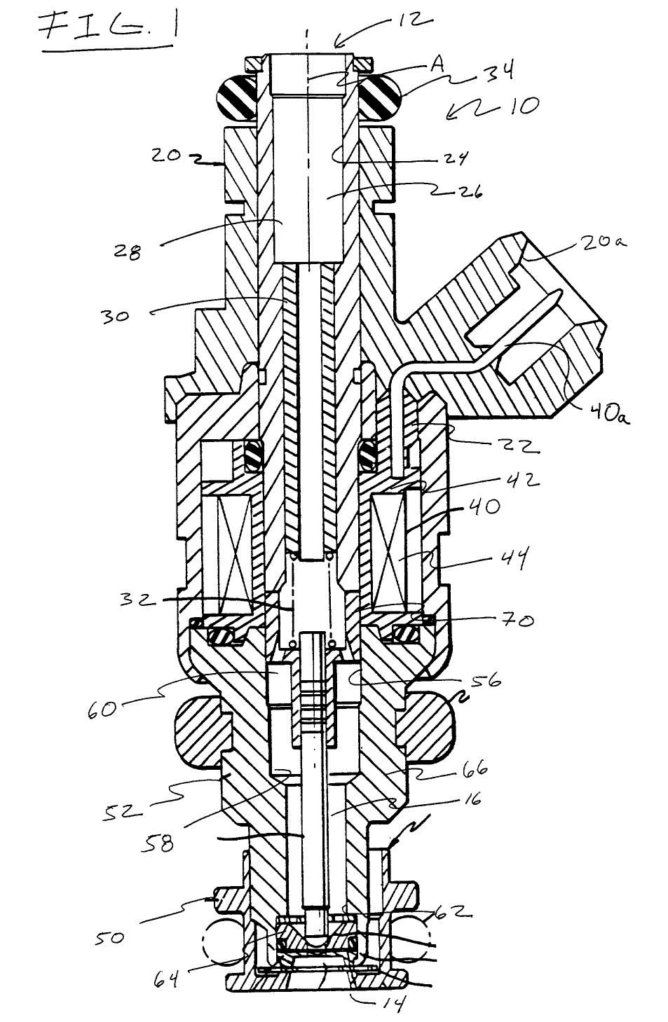

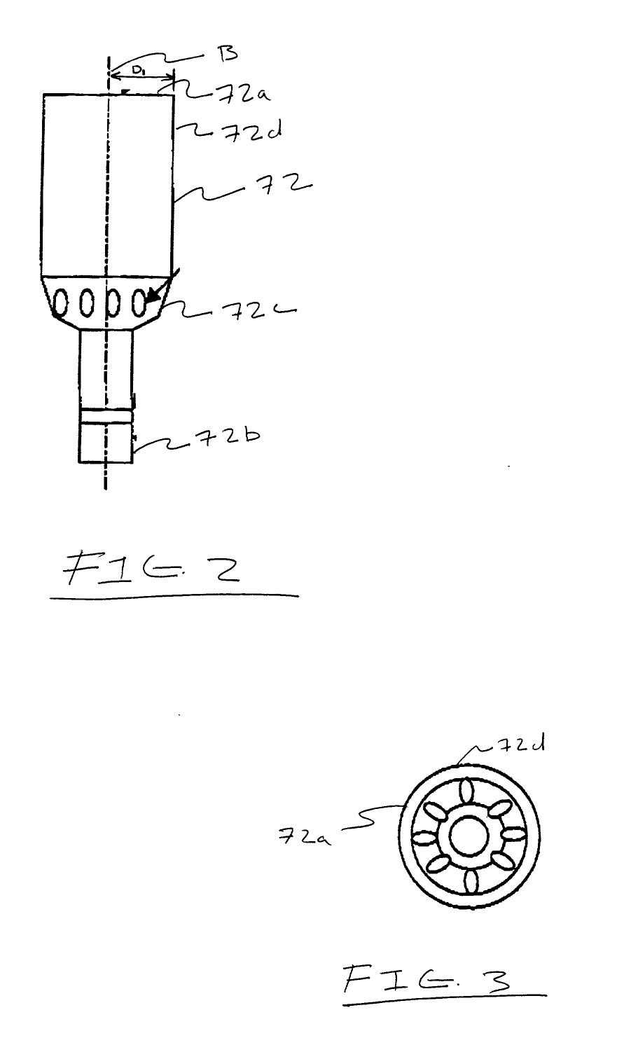

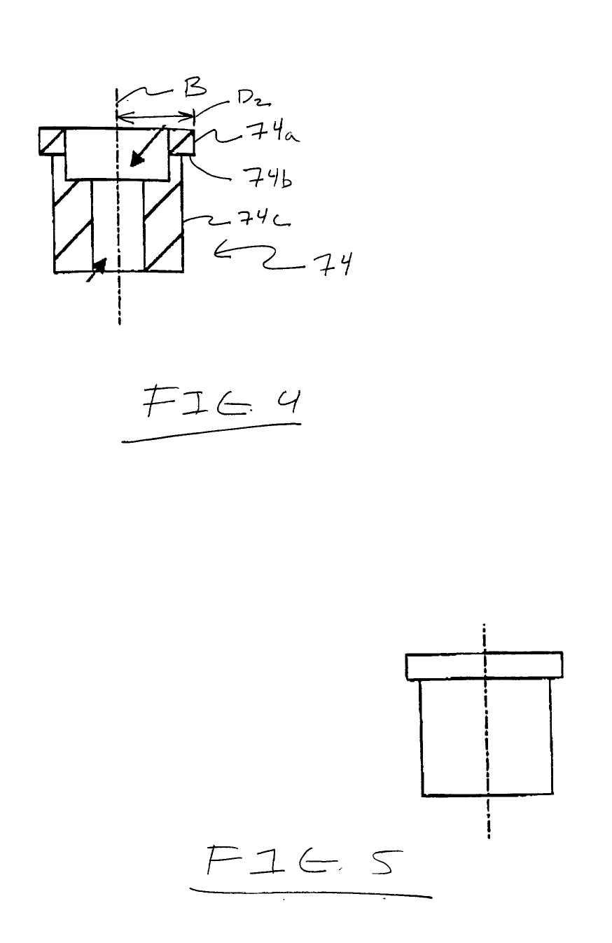

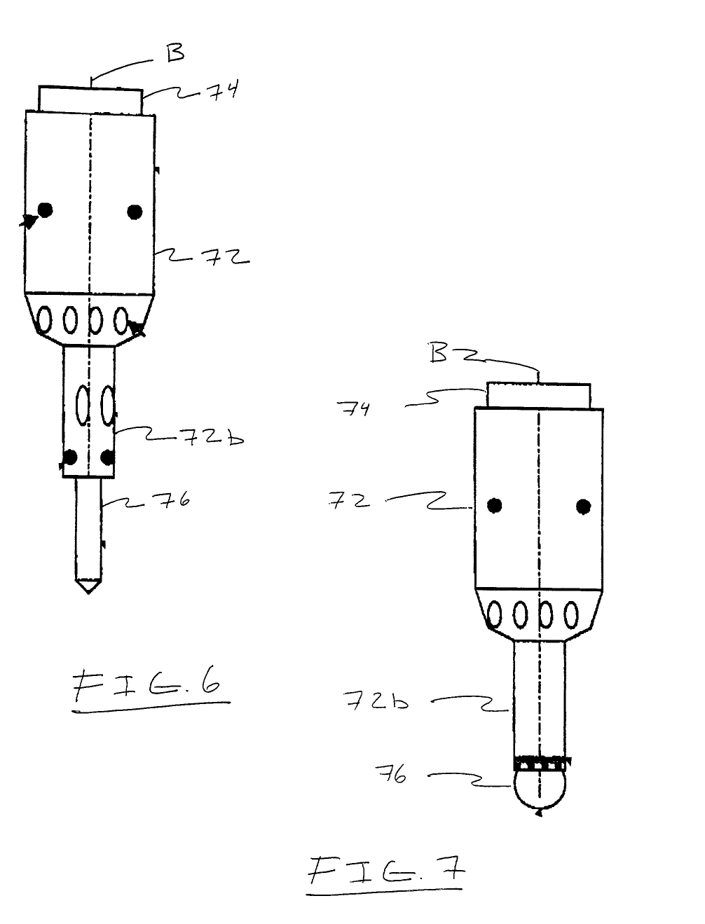

FIG. 1 shows an example of a fuel injector 10 including a closure member 70. The fuel injector assembly 10 has a housing, which includes a fuel inlet 12, a fuel outlet 14, and a fuel passageway 16 extending from the fuel inlet 12 to the fuel outlet 14 along a longitudinal axis A. The housing includes an overmolded plastic member 20 cincturing a metallic support member 22.

A fuel inlet member 24 with an inlet passage 26 is disposed within the overmolded plastic member 20. The inlet passage 26 serves as part of the fuel passageway 16 of the fuel injector assembly 10. A fuel filter 28 and an adjustable tube 30 are provided in the inlet passage 26. The adjustable tube 30 is positionable along the longitudinal axis A before being secured in place, thereby varying the length of an armature bias spring 32. In combination with other factors, the length of the spring 32, and hence the bias force against the closure member 70, controls the quantity of fuel flow through the injector. The overmolded plastic member 20 also supports a socket 20a that receives a plug (not shown) to operatively connect the fuel injector assembly 10 to an external source of electrical potential, such as an electronic control unit (not shown). An elastomeric O-ring 34 is provided in a groove on an exterior of the inlet member 24 to sealingly secure the inlet member 24 to a fuel supply member (not shown), such as a fuel rail.

The metallic support member 22 encloses an electromagnetic actuator assembly. An example of the actuator is a coil assembly 40. The coil assembly 40 includes a bobbin 42 that retains a coil 44. The ends of the coil assembly 40 are electrically connected to pins 40a mounted within the socket 20a of the overmolded plastic member 20. The closure member 70 is supported for relative movement along the longitudinal axis A with respect to the inlet member 24. The closure member 70 is supported by a body shell 50 and a body 52.

The body shell 50 engages the body 52. An armature guide eyelet 56 is located on an inlet portion 60 of the body 52. An axially extending body passage 58 connects the inlet portion 60 of the body 52 with an outlet portion 62 of the body 52. A seat 64, which is preferably a metallic material, is mounted at the outlet portion 62 of the body 52.

The body 52 includes a neck portion 66 that extends between the inlet portion 60 and the outlet portion 62. The neck portion 66 can be an annulus that surrounds a portion of the closure member 70.

Operative performance of the fuel injector assembly 10 is achieved by magnetically coupling the closure member 70 to the end of the inlet member 26 that is closest to the inlet portion 60 of the body 52. Thus, the lower portion of the inlet member 26 that is proximate to the closure member 70 serves as part of the magnetic circuit formed with the coil assembly 40. The closure member 70 is guided by the armature guide eyelet 56 and is responsive to an electromagnetic force generated by the coil assembly 40 for axially reciprocating the closure member 70 along the longitudinal axis A of the fuel injector assembly 10. The electromagnetic force is generated by current flow from the electronic control unit (not shown) through the coil assembly 40. Movement of the closure member 70 opens and closes the seat passage 66 of the seat 64, which permits or inhibits, respectively, fuel from flowing through the fuel outlet 14 of the fuel injector 10.

Fuel that is to be injected from the fuel injector 10 is communicated from the fuel inlet source (not shown), to the fuel inlet 12, through the fuel passageway 16, and exits from the fuel outlet 14. The fuel passageway 16 includes the inlet passage 26 of the inlet member 24, the body passage 58 of the body 52, and the seat passage 66 of the seat 64.

The closure member 70 will now be discussed in greater detail. The closure member 70 is disposed in the fuel injector housing and is operable by the coil assembly 40 to permit and prohibit fuel flow through the seat passage 66 of the seat 64. The closure member 70 provides a working surface for a working gap with the coil assembly 40. Preferably, the working gap can be less than about 100 microns. Although the closure member can be an integral component, in a preferred embodiment, as shown in the drawings, the closure member 70 can include multiple components. Preferably the closure member 70 includes a sleeve 72 and an armature 74. More preferably, the closure member 70 also includes a sealing member 76.

The sleeve 72 provides the working surface for the working gap with an interior surface of the coil assembly 400. While the sleeve 72 can be any shape, in a preferred embodiment, as shown in the drawings, the sleeve 72 can be an annulus that extends along a longitudinal axis B, and can include a first end 72a, a second end 72b, and a transition portion 72c disposed therebetween, each having a different diameter. Preferably, an outer surface 72d a distance D1 from the longitudinal axis B provides the working surface. The working surface of the sleeve 72 can be out of roundness with the longitudinal axis A of the fuel injector 10. The longitudinal axis B of the sleeve 72 can be about coaxial with the longitudinal axis A of the fuel injector 10. Although the sleeve 72 is preferably a thin-walled member that can be formed by stamping and drawing, the sleeve 72 can be any member that includes a surface capable of defining the working gap with the coil assembly and/or actuator.

The armature 74 can be coupled to the sleeve 72, and preferably is coupled to the first end 72a of the sleeve 72. In a preferred embodiment, as shown in the figures, the armature 74 is coupled to the sleeve 72 by disposing at least a portion of the armature 74 in the first end 72a of the sleeve 72, and securing the armature 74 to the sleeve 72. Preferably, a tack weld and/or seam weld can be used to couple the components. However, it is to be understood that the armature 74 can be coupled to the sleeve 72 by any connection so long as relative movement of the sleeve 72 provides relative movement to the armature 74.

The armature 74 provides advantage during assembly of the closure member 70 in that the armature 74 need not be manufactured or installed to tight tolerances, since the working surface for the working gap is provided by the sleeve 72. Thus, the armature 74 need only be manufactured to tolerances sufficient for its application. Further, the armature 74 need only provide sufficient size and mass to permit satisfactory coupling to the sleeve 72 and to provide desired electromagnetic actuation by the coil assembly 40. The armature 74 can include an outer perimeter 74a a distance D2 from the longitudinal axis B, where the distance D2 is not greater than the distance D1. In a preferred embodiment, the armature 74 can include a stop portion 74b and a lower portion 74c. The stop portion 74b can include the outer perimeter 74a, and can contact at least a portion of the first end 72a of the sleeve 72. The lower portion 74c can be disposed at least partially in the first end 72a of the sleeve 72.

In a more preferred embodiment, each of the sleeve 72 and the armature 74 can include at least one flow hole therethrough, the flow holes defining an internal fuel passage from the fuel inlet 12 to the fuel outlet 14 of the fuel injector 10. Preferably, the at least one flow hole in the armature 74 can be an oval shape. The at least one flow hole in the sleeve 72 can be disposed on the second end 72b, and can be disposed on the transition portion 72c. It is understood that when the sleeve 72 and armature 74 do not provide an internal fuel passage or flow path, fuel can flow from the fuel inlet 12 to the fuel outlet 14 by flowing around the closure member 70 and/or through the working gap between the closure member 70 and the actuator.

FIG. 8 shows examples of magnetic flux flow paths through the closure member 70 having a magnetic armature and a non-magnetic sleeve. In the fuel injector assembly 10, it is known to generate the electromagnetic force for axially reciprocating the closure member 70 through energization of the coil assembly 40. The electromagnetic force can flow through the interior surface of the coil assembly 400 to the closure member 70.

Magnetic flux flow paths A indicates an example of a flow of electromagnetic force from the coil assembly 40 to a magnetic armature 74 and a non-magnetic sleeve 72. As illustrated in the figure, the flow of electromagnetic force is concentrated through the magnetic sleeve 74. Magnetic flux flow paths B indicate the flow of electromagnetic force that is “choked-off” and prohibited from flowing through the closure member 70 due to the use of a non-magnetic sleeve 72 and a working gap between the interior surface of the coil assembly 400 and the armature 72 that is less than a thickness of the armature 74.

A pole piece or stator can be optimized and disposed above the armature 74 of the closure member 70, such that a direction of the magnetic flux flow paths A is optimized to provide desired electromagnetic characteristics for the magnetic circuit.

The sealing member 76 can be disposed at an end of the closure member 70 to engage the seat 64, thereby permitting and preventing fuel flow from the fuel outlet 14 of the fuel injector 10. Although in a preferred embodiment, as shown in the drawings, the sealing member 76 is a separate member that is coupled to the sleeve 72, it is to be understood that the sealing member 76 can be a portion of the sleeve 72, and can be a portion of the second end 72b of the sleeve 72. As with the armature, the sealing member 76 can be coupled to the sleeve 72 by disposing at least a portion of the sealing member 76 in the second end 72b of the sleeve and/or by any connection so long as relative movement of the sleeve 72 provides relative movement to the sealing member 76. In a preferred embodiment, the sealing member 76 can be a spherical shaped member, and the spherical shaped member can be a ball and/or a needle.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What we claim is:

1. A fuel injector having a housing including an inlet, an outlet, and a passageway for fuel flow from the inlet to the outlet, the fuel injector comprising:
a coil assembly disposed proximate the inlet of the fuel injector;
a seat disposed proximate the outlet of the fuel injector; and
a closure member disposed in the housing and operable by the coil assembly to permit and prohibit fuel flow through the seat, the closure member including;
a sleeve extending along a longitudinal axis and having first and second ends, the sleeve including an outer surface a first distance from the longitudinal axis; and
an armature coupled to the first end of the sleeve, the armature having an outer perimeter a second distance from the longitudinal axis, the second distance not greater than the first distance.

2. The fuel injector according to claim 1, wherein the coil assembly comprises an inner surface, the outer surface of the sleeve and the inner surface of the coil assembly defining a working gap less than 100 microns.

3. The fuel injector according to claim 1, further comprising a sealing member coupled to the second end of the sleeve.

4. The fuel injector according to claim 1, wherein the sealing member comprises a spherical shaped member to engage the seat.

5. The fuel injector according to claim 4, wherein the spherical shaped member comprises at least one of a ball and a needle.

6. The fuel injector according to claim 1, wherein at least one of the outer surface of the sleeve and the outer perimeter of the armature is circular.

7. The fuel injector according to claim 1, wherein the armature is disposed entirely within a volume defined by the outer surface of the sleeve extending along the longitudinal axis.

8. The fuel injector according to claim 1, wherein the armature includes a stop portion, the stop portion defining the outer perimeter and contacting at least a portion of the first end of the sleeve.

9. The fuel injector according to claim 1, wherein each of the sleeve and the armature includes at least one flow hole therethrough, the flow holes defining a fuel passage from the inlet to the outlet of the fuel injector.

10. The fuel injector according to claim 9, wherein the at least one flow hole in the armature comprises an oval shape.

11. The fuel injector according to claim 10, wherein the at least one flow hole in the sleeve is disposed on the second end of the sleeve.

12. The fuel injector according to claim 10, wherein the at least one flow hole in the sleeve is disposed on a transition portion between the first and second ends.

13. The fuel injector according to claim 3, wherein at least one of the armature and the sealing member are coupled to the sleeve by a tack weld.

14. The fuel injector according to claim 3, wherein at least one of the armature and the sealing member are coupled to the sleeve by a seam weld.

15. The fuel injector according to claim 1, wherein the sleeve comprises at least one of a stamped member and thin-walled drawn member.

16. A method of defining a working gap of less than 100 microns in a fuel injector including an electromagnetic actuator having an inner surface, and a closure member having a longitudinal axis and operable by the electromagnetic actuator, comprising:
providing the closure member with a sleeve and an armature coupled to the sleeve such that the sleeve provides a working surface for the working gap; and
establishing the working gap of less than 100 microns between the inner surface of the electromagnetic actuator and the working surface of the sleeve.

17. The method according to claim 16, wherein the armature is disposed entirely within a volume defined by the working surface of the sleeve extending along the longitudinal axis.

18. A closure assembly for a fuel injector including a housing, comprising:
an electromagnetic actuator disposed in the housing and having an inner surface;
a closure member disposed in the housing and operable by the actuator to permit and prohibit fuel flow through the fuel injector, the closure member including;
a sleeve extending along a longitudinal axis, the sleeve having an end and an outer surface; and
an armature coupled to the end of the sleeve and disposed entirely within a volume of the outer surface of the sleeve extending along the longitudinal axis.
